(19) United States
(12) Patent Application Publication
(10) Pub. No.: US 2009/0264086 A1
(43) Pub. Date: Oct. 22, 2009

(54) WIRELESS COMMUNICATION DEVICE

(75) Inventors: Ai-Ning Song, Shenzhen City (CN); Chong Xu, Shenzhen City (CN); Qi-Jian Hu, Shenzhen City (CN); Teng-Huei Chu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO.,LTD., Shenzhen City (CN); HON HAI PRECISION INDUSTRY CO., LTD., Tu-Cheng (TW)

(21) Appl. No.: 12/261,040

(22) Filed: Oct. 30, 2008

(30) Foreign Application Priority Data
Apr. 22, 2008 (CN) 200810301251.8

(51) Int. Cl. H04B 1/44

(52) U.S. Cl. 455/90.2

(57) ABSTRACT

A wireless communication device includes an antenna module, a transceiving module, a controlling module, and a switch module. The antenna module includes a first antenna and a second antenna. The transceiving module includes a first transceiver and a second transceiver. The controlling module receives a first control signal and a working status signal from the first transceiver, subsequently outputting a second control signal according to the first control signal and the working status signal. The switch module includes a first single-pole-double-throw (SPDT) switch connected to the first transceiver and a double-pole-double-throw (DPDT) switch. The DPDT switch is connected between the antenna module and the first SPDT switch as well as the second transceiver and configured for switching the connections of the first SPDT switch, the second transceiver, the first antenna, and the second antenna according to the second control signal.

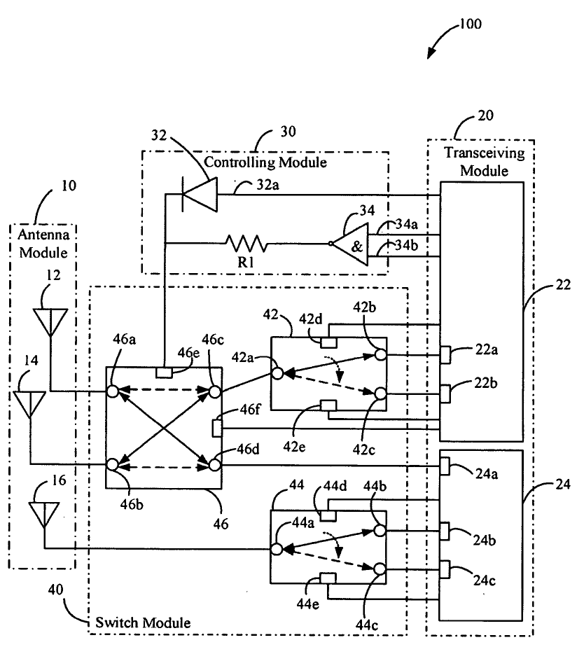

### BACKGROUND

1. Field of the Invention

Embodiments of the present disclosure relate to wireless communications, and more particularly to a wireless communication device.

2. Description of Related Art

With developments of wireless communication technology, more and more wireless communication devices support multiple bands. For example, a computer may support wireless technology, such as Wi-Fi and Worldwide Interoperability for Microwave Access (WiMAX). In addition, developments of technology regarding multiple antennas allow most of such wireless communication devices to have multiple antennas, thereby providing multiple signal transmission paths. However, it is difficult to make multiple signal transmission paths coexist in such wireless communication devices.

### SUMMARY

A wireless communication device includes an antenna module, a transceiving module, a controlling module, and a switch module. The antenna module includes a first antenna and a second antenna. The transceiving module includes a first transceiver and a second transceiver. The controlling module is configured for receiving a first control signal and a working status signal from the first transceiver, subsequently outputting a second control signal according to the first control signal and the working status signal. The switch module includes a first single-pole-double-throw (SPDT) switch connected to the first transceiver and a double-pole-double-throw (DPDT) switch. The DPDT switch is connected between the antenna module and the first SPDT switch as well as the second transceiver and configured for switching the connections of the first SPDT switch, the second transceiver, the first antenna, and the second antenna according to the second control signal.

Other advantages and novel features of the present disclosure will be drawn from the following detailed description, in which:

### BRIEF DESCRIPTION OF THE DRAWINGS

The figure is a schematic diagram of an embodiment of a wireless communication device of the present disclosure.

### DETAILED DESCRIPTION OF CERTAIN INVENTIVE EMBODIMENTS

The figure is a schematic diagram of an embodiment of a wireless communication device 100 of the present disclosure. In one embodiment, the wireless communication device 100 may be a network adapter or a mobile phone which supports Wi-Fi and Worldwide Interoperability for Microwave Access (WiMAX). Working bands of Wi-Fi is 2.4 GHz, while working bands of WiMAX is from 2.5 GHz to 2.7 GHz in one embodiment. In other embodiments, the wireless communication device 100 may be other devices that support other frequency bands.

In one embodiment, the wireless communication device 100 includes an antenna module 10, a transceiving module 20, a controlling module 30 and a switch module 40. The modules 10, 20, 30, 40 may be used to execute one or more operations for the wireless communication device 100.

The antenna module 10 includes a first antenna 12, a second antenna 14, and a third antenna 16. In one embodiment, the first antenna 12 and the second antenna 14 support Wi-Fi and WiMAX, namely working in frequency bands from 2.4 GHz to 2.7 GHz. The third antenna 16 supports WiMAX, namely working in frequency bands from 2.5 GHz to 2.7 GHz. In other embodiments, the antenna module 10 may support antennas that work in other frequency bands.

The transceiving module 20 includes a first transceiver 22 and a second transceiver 24. In one embodiment, the first transceiver 22 may be a chipset that supports Wi-Fi wireless communication. The first transceiver 22 includes an input 22a and an output 22b. The second transceiver 24 may be a multiple input single output (MISO) chipset that supports WiMAX wireless communication. The second transceiver 24 includes a first input 24a, a second input 24b, and an output 24c. In other embodiments, the transceiving module 20 may include chipsets working in other frequency bands.

The controlling module 30 is configured for receiving a first control signal and a working status signal from the first transceiver 22, subsequently outputting a second control signal according to the first control signal and the working status signal so as to control switching of the switch module 40. In one embodiment, the first control signal and the working status signal may be indicated by a high or a low level signal. As used herein, a high level signal corresponds to a logical 1 and a low level signal corresponds to a logical 0. In one embodiment, the working status of the first transceiver 22 may be “enable,” “sleep,” or “disable.” The working status signal includes a first working status signal and a second working status signal.

In one embodiment, the first working status signal indicates whether the first transceiver 22 is in the working status of “sleep” or not. The first working status signal may be a low level signal if the first transceiver 22 is in the working status of “sleep” and may be a high level signal if the first transceiver 22 is not in the working status of “sleep.” The second working status signal indicates whether the first transceiver 22 is in the working status of “disable” or not. The second working status signal may be a low level signal if the second transceiver 24 is in the working status of “disable” and may be a high level signal if the first transceiver 22 is not in the working status of “disable.”

In one embodiment, the working status of the first transceiver 22 is “enable” if the working status of the first transceiver 22 is neither “sleep” nor “disable.” The first working status signal and the second working status signal may both be a high level signal if the first transceiver 22 is in the working status of “enable.” As such, the second control signal from the controlling module 30 may be the same as the first control signal if the first transceiver 22 is in the working status of “enable.” The second control signal from the controlling module 30 may be a high level signal if the first transceiver 22 is in the working status of “sleep” or “disable.”

In one embodiment, the controlling module 30 includes a diode 32, a logic operator 34, and a resistor R1.

A positive end 32a of the diode 32 receives the first control signal from the first transceiver 22. A first input 34a of the logic operator 34 is connected to the first transceiver 22 for receiving the first working status signal, and a second input 34b of the logic operator 34 is connected to the first transceiver 22 for receiving the second working status signal.

The logic operator 34 outputs a high level signal if the first input 34a or the second input 34b of the logic operator 34 receives a low level signal from the first transceiver 22, that is, the first transceiver 22 is in the working status of “sleep” or “disable.” The logic operator 34 outputs a low level signal if the first input 34a and the second input 34b of the logic operator 34 both receive a high level signal, that is, the first transceiver 22 is in the working status of “enable.” In one embodiment, the logic operator 34 may be a NAND gate.

The resistor R1 is connected between a negative end of the diode 32 and an output of the logic operator 34. A node of the negative end of the diode 32 and the resistor R1 collectively form an output of the controlling module 30 for outputting the second controlling signal. As such, the second control signal from the controlling module 30 may be the same as the first control signal if the logic operator 34 outputs a low level signal. The second control signal from the controlling module 30 may be a high level signal if the logic operator 34 outputs a high level signal.

The switch module 40 includes a first single-pole-double-throw (SPDT) switch 42, a second SPDT switch 44, and a double-pole-double-throw (DPDT) switch 46.

The first SPDT switch 42 is connected between the first transceiver 22 and the DPDT switch 46. In one embodiment, a common terminal 42a of the first SPDT switch 42 is connected to the DPDT switch 46. A first terminal 42b and a second terminal 42c of the first SPDT switch 42 are respectively connected to an input 22a and an output 22b of the first transceiver 22.

A first input 42d and a second input 42e of the first SPDT switch 42 are both connected to the first transceiver 22, for connecting the common terminal 42a of the first SPDT switch 42 to the first terminal 42b of the first SPDT switch 42 or to the second terminal 42c of the first SPDT switch 42 according to the first control signal from the first transceiver 22. In one embodiment, the common terminal 42a of the first SPDT is connected to the first terminal 42b of the first SPDT switch 42 if the first input 42d of the first SPDT switch 42 receives a high level signal and the second input 42e of the first SPDT switch 42 receives a low level signal from the first transceiver 22. The common terminal 42a of the first SPDT switch 42 is connected to the second terminal 42c of the first SPDT switch 42 if the first input 42d of the first SPDT switch 42 receives a low level signal and the second input 42e of the first SPDT switch 42 receives a high level signal from the first transceiver 22.

The DPDT switch 46 is connected between the antenna module 10 and the first SPDT switch 42 as well as the second transceiver 24 and configured for switching connections of the first SPDT switch 42, the second transceiver 24, the first antenna 12, and the second antenna 14 according to the second control signal. In one embodiment, a first terminal 46a and a second terminal 46b of the DPDT switch 46 are respectively connected to the first antenna 12 and the second antenna 14, a third terminal 46c of the DPDT switch 46 is connected to the common terminal 42a of the first SPDT switch 42, and a fourth terminal 46d of the DPDT switch 46 is connected to a first input 24a of the second transceiver 24.

A first input 46e of the DPDT switch 46 is connected to the output of the controlling module 30 and a second input 46f of the DPDT switch 46 is connected to the first transceiver 22. The first input 46e and the second input 46f of the DPDT switch 46 are configured for connecting two terminals of the first terminal 46a, the second terminal 46b, the third terminal 46c, and the fourth terminal 46d of the DPDT switch 46 according to the second control signal from the controlling module 30 and the first control signal from the first transceiver 22. In one embodiment, the first terminal 46a of the DPDT switch 46 is connected to the fourth terminal 46d of the DPDT switch 46 and the second terminal 46b of the DPDT switch 46 is connected to the third terminal 46c of the DPDT switch 46 if the first input 46e of the DPDT switch 46 receives a high level signal and the second input 46f of the DPDT switch 46 receives a low level signal from the first transceiver 22. The first terminal 46a of the DPDT switch 46 is connected to the third terminal 46c of the DPDT switch 46 and the second terminal 46b of the DPDT switch 46 is connected to the fourth terminal 46d of the DPDT switch 46 if the first input 46e of the DPDT switch 46 receives a low level signal and the second input 46f of the DPDT switch 46 receives a high level signal from the first transceiver 22.

The first transceiver 22 selects an antenna that has a better signal from the first antenna 12 and the second antenna 14 for transceiving signals by outputting different level signals to the first input 46e and the second input 46f of the DPDT switch 46 if the first transceiver 22 is in the working status of “enable.” For example, if the signal from the second antenna 14 is better (e.g., stronger, less distortion), the first transceiver 22 may select the second antenna 14. Likewise, if the signal from the first antenna 12 is better, then the first transceiver 22 may select the first antenna 12. As such, the remaining antenna of the first antenna 12 and the second antenna 14 is connected to the second transceiver 24. In this embodiment, the third antenna 16 is only connected to the second transceiver 24 and only works with the second transceiver 24. As such, the second transceiver 24 may have a better signal in contrast to when the third antenna 16 simultaneously works with the first transceiver 22 and the second transceiver 24. Therefore, the first transceiver 22 and the second transceiver 24 both have better signals via the antennas of the antenna module 10.

In one embodiment, the controlling module 30 outputs a high level signal to the first input 46e of the DPDT switch 46 and the first transceiver 22 outputs a low level signal to the second input 46f of the DPDT switch 46 when the first transceiver 22 is in the working status of “sleep” or “disable.” As such, the DPDT switch 46 connects the fourth terminal 46d and the first terminal 46a of the DPDT switch 46. Therefore, the second transceiver 24 can transceive signals via the first antenna 12 even if the first transceiver 22 is in the working status of “sleep” or “disable.” In other embodiments, the first transceiver 22 may output a high level signal when the first transceiver 22 is in the working status of “sleep” or “disable,” depending on the original configuration of the first transceiver 22. As such, the controlling module 30 is configured for outputting the second controlling signal which is a low level signal when the first transceiver 22 is in the working status of “sleep” or “disable.”

The second SPDT switch 44 is connected between the second transceiver 24 and the third antenna 16. In one embodiment, a common terminal 44a of the second SPDT switch 44 is connected to the third antenna 16. A first terminal 44b and a second terminal 44c of the second SPDT switch 44 are respectively connected to a second input 24b and an output 24c of the second transceiver 24. A first input 44d and a second input 44e of the second SPDT switch 44 are both connected to the second transceiver 24, which is configured for connecting the common terminal 44a of the second SPDT switch 44 to the first terminal 44b of the second SPDT switch 44 or to the second terminal 44c of the second SPDT switch 44.

In one embodiment, the common terminal 44a of the second SPDT switch 44 is connected to the first terminal 44b of the second SPDT switch 44 if the first input 44d of the second SPDT switch 44 receives a high level signal and the second input 44e of the second SPDT switch 44 receives a low level signal from the second transceiver 24. The common terminal 44a of the second SPDT switch 44 is connected to the second terminal 44b of the second SPDT switch 44 if the first input 44d of the second SPDT switch 44 receives a low level signal and the second input 44e of the second SPDT switch 44 receives a high level signal from the second transceiver 24.

The present disclosure is not limited to the schematic diagram of the figure. For example, the wireless communication device 100 can also operate normally without the third antenna 16 of the antenna module 10, the second SPDT switch 44 of the switch module 40. High and a low level signals can also be exchanged according to different requirements. It may be understood that the first and second SPDT switch 42, 44 may be cut off if the first input 42d, 44d and the second input 42e, 44e of the first and second SPDT switch 42, 44 both receive a high level signal or a low level signal. The DPDT switch 46 may be cut off if the first input 46e and the second input 46f of the DPDT switch 46 both receive a high level signal or a low level signal.

The wireless communication device 100 switches connections between the plurality of antennas 12, 14, 16 of the antenna module 10 and the plurality of transceivers 22, 24 of the transceiving module 20 via the controlling module 30 and the switching module 40. Therefore, there are multiple signal transmission paths coexisting in the wireless communication device 100, which allows the wireless communication device 100 to operate under multiple bands. In addition, the first transceiver 22 can select an antenna that has a better signal from the first antenna 12 and the second antenna 14 for transceiving signals via the DPDT switch 46. The second transceiver 24 has an appropriative antenna, namely the third antenna 16, for transceiving signals. Furthermore, due to the controlling module 30, the second transceiver 24 can transceive signals via the first antenna 12 or the second antenna 14 even if the first transceiver 22 is not working.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A wireless communication device, comprising:
an antenna module comprising a first antenna and a second antenna;
a transceiving module comprising a first transceiver and a second transceiver;
a controlling module configured for receiving a first control signal and a working status signal from the first transceiver, and for subsequently outputting a second control signal according to the first control signal and the working status signal; and
a switch module, comprising:
a first single-pole-double-throw (SPDT) switch connected to the first transceiver; and
a double-pole-double-throw (DPDT) switch connected between the antenna module and the first SPDT switch as well as the second transceiver, and configured for switching the connections of the first SPDT switch, the second transceiver, the first antenna, and the second antenna according to the second control signal.

2. The wireless communication device as claimed in claim 1, wherein the working status signal comprises:
a first working status signal indicating whether the first transceiver is in a sleep status or not in a sleep status; and
a second working status signal indicating whether the first transceiver is in a disable status or not in a disable status.

3. The wireless communication device as claimed in claim 2, wherein the controlling module comprises:
a diode, wherein a positive end of the diode is connected to the first transceiver for receiving the first control signal;
a logic operator, wherein a first input of the logic operator is connected to the first transceiver for receiving the first working status signal, and a second input of the logic operator is connected to the first transceiver for receiving the second working status signal; and
a resistor connected between a negative end of the diode and an output of the logic operator;
wherein a node of the negative end of the diode and the resistor forms an output of the controlling module, for outputting the second controlling signal to the DPDT switch.

4. The wireless communication device as claimed in claim 3, wherein the logic operator comprises a NAND gate.

5. The wireless communication device as claimed in claim 1, wherein a common terminal of the first SPDT switch is connected to the DPDT switch, and a first terminal and a second terminal of the first SPDT switch are respectively connected to an input and an output of the first transceiver.

6. The wireless communication device as claimed in claim 5, wherein a first input and a second input of the first SPDT switch are both connected to the first transceiver for connecting the common terminal of the first SPDT switch to the first terminal or the second terminal of the first SPDT switch according to the first control signal from the first transceiver.

7. The wireless communication device as claimed in claim 5, wherein a first terminal and a second terminal of the DPDT switch are respectively connected to the first antenna and the second antenna, a third terminal of the DPDT switch is connected to the common terminal of the first SPDT switch, and a fourth terminal of the DPDT switch is connected to a first input of the second transceiver.

8. The wireless communication device as claimed in claim 7, wherein a first input of the DPDT switch is connected to an output of the controlling module, and a second input of the DPDT switch is connected to the first transceiver for connecting two terminals of the first terminal, the second terminal, the third terminal, and the fourth terminal of the DPDT switch according to the second control signal from the controlling module and the first control signal from the first transceiver.

9. The wireless communication device as claimed in claim 1, wherein the antenna module further comprises a third antenna, and the switch module further comprises a second SPDT switch connected between the second transceiver and the third antenna.

10. The wireless communication device as claimed in claim 9, wherein a common terminal of the second SPDT switch connects with the third antenna, a first terminal and a second terminal of the second SPDT are respectively connected to a second input of the second transceiver and an output of the second transceiver.

11. The wireless communication device as claimed in claim 10, wherein a first input and a second input of the second SPDT switch are both connected to the second transceiver for connecting the common terminal of the second SPDT switch to the first terminal or the second terminal of the second SPDT switch.

12. A wireless communication device, comprising:
an antenna module comprising a plurality of antennas;
a transceiving module comprising a plurality of transceivers;
a switch module configured for switching connections between one or more of the plurality of antennas and one or more of the plurality of transceivers; and
a controlling module configured for receiving a first control signal and a working status signal sent from one of the plurality of transceivers, and for outputting a second control signal according to the first control signal and the working status signal so as to control the switching of the switch module.

13. The wireless communication device as claimed in claim 12, wherein the working status signal comprises:
a first working status signal indicating whether said one of the transceivers sending the working status signal is in a sleep status or not in a sleep status; and
a second working status signal indicating whether said one of the transceivers sending the working status signal is in a disable status or not in a disable status.

14. The wireless communication device as claimed in claim 13, wherein the second control signal is the same as the first control signal if said one of the transceivers sending the working status signal is not in the sleep status as well as not in the disable status, whereas the second control signal is a high level signal.

15. The wireless communication device as claimed in claim 14, wherein the controlling module comprises:
a diode, a positive end of the diode receiving the first control signal from said one of the plurality of transceivers sending the working status signal;
a logic operator, a first input of the logic operator being configured for receiving the first working status signal, a second input of the logic operator being configured for receiving the second working status signal; and
a resistor connected between a negative end of the diode and an output of the logic operator;
wherein a node of the negative end of the diode and the resistor form an output of the controlling module for outputting the second controlling signal to the switch module.

16. The wireless communication device as claimed in claim 15, wherein the logic operator comprises a NAND gate.
